(19) United States
(12) Patent Application Publication
(10) Pub. No.: US 2025/0245003 A1
(43) Pub. Date: Jul. 31, 2025

(54) Pipelined Decoding Microarchitecture Design Method for RISC-V Vector Instructions

(71) Applicant: Jiangsu Huachuang Microsystem Company Limited, Nanjing (CN)

(72) Inventors: Yingkuo YUAN, Nanjing (CN); Ming HAO, Nanjing (CN)

(73) Assignee: Jiangsu Huachuang Microsystem Company Limited, Nanjing (CN)

(21) Appl. No.: 19/008,702

(22) Filed: Jan. 3, 2025

(30) Foreign Application Priority Data
Jan. 25, 2024 (CN) 202410102578.1

(51) Int. Cl. G06F 9/22; G06F 9/30

(52) U.S. Cl. CPC G06F 9/223; G06F 9/30036

(57) ABSTRACT

A pipelined decoding microarchitecture design method for RISC-V vector instructions includes the following steps: S1, extracting an instruction packet according to a PC, performing preprocessing, and writing a preprocessing result, each instruction field and preprocessed instruction information into a cache; S2, reading the cache, obtaining pre-decoding result data and recognizing each configuration instruction; S3, transmitting the pre-decoding result data to an instruction buffer, and acquiring field information, a split quantity and predicted vtype information; and splitting each instruction into multiple microoperations, and constructing a queue to store each microoperation; and S4, transmitting first, by means of the queue, each configuration instruction, performing decoding and execution, acquiring vtype information generated after execution, and when the vtype information generated after execution is identical with the predicted vtype information, controlling the number of microoperations input to multiple decoders, and transmitting a decoding result to an instruction slot.

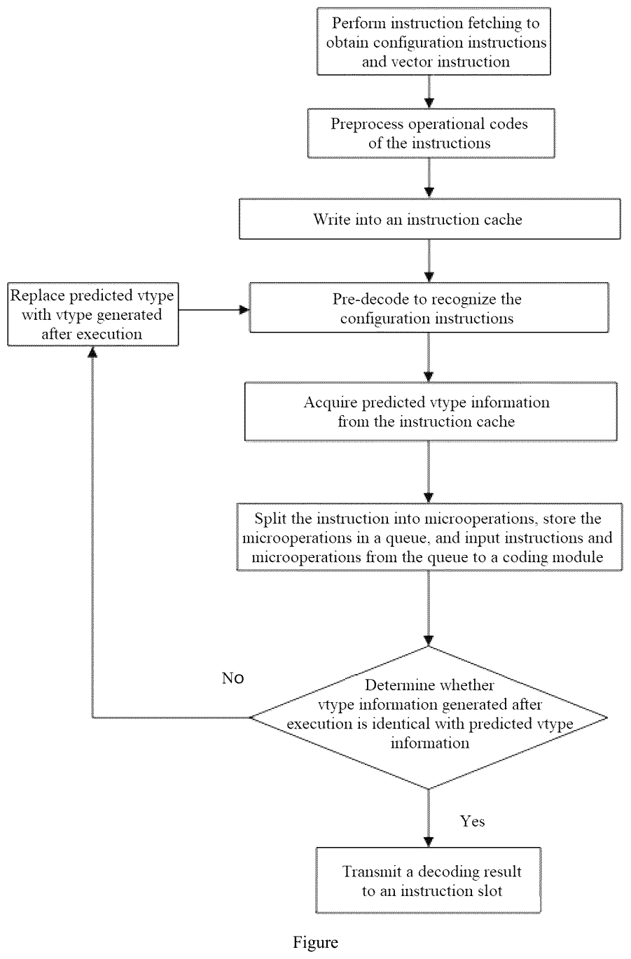

### CROSS REFERENCE TO THE RELATED APPLICATIONS

This application is based upon and claims priority to Chinese Patent Application No. 202410102578.1, filed on Jan. 25, 2024, the entire contents of which are incorporated herein by reference.

### TECHNICAL FIELD

The invention relates to the technical field of processor design, in particular to a pipelined decoding microarchitecture design method for Reduced Instruction Set Computing-Version Five (RISC-V) vector instructions.

### BACKGROUND

The RISC-V vector extension (abbreviated to RVV) is based on a traditional vector machine, adopts a variable vector length and uses multiple registers as a register file cited as a single operand. Modern high-performance processors are designed often by means of a multi-stage pipelined out-of-order superscalar approach, which uses a microarchitecture based on out-of-order execution and register renaming, but it only supports operations on a single register. Therefore, the use of the RVV for designing such a microarchitecture is proposed to adapt to operations on multiple registers.

At present, to adapt to the features of the RVV, a series of corresponding architectures in existing superscalar processors supporting out-of-order execution and register renaming have to be modified, and core problems that are difficult to solve are as follows: (1) there are instruction conflicts between logic implementation of a RISC-V vector register file and logic implementation of the superscalar processors supporting register renaming and out-of-order execution, making it impossible to realize synchronous running of the RISC-V vector register file and the superscalar processors; (2) fetched instructions are not processed and directly decoded in the decoding stage, so bubbles are easily generated; a pause of instruction fetch or deletion of fetched instructions in an instruction pipeline will lead to a degradation of performance; (3) in the processing process, configuration instructions and a proportion of other instructions to be executed cannot be decoded normally, leading to a loss of instructions and a false result.

### SUMMARY

The technical issue to be settled by the invention is how to realize synchronous running of vector register files and superscalar processors supporting register renaming and out-of-order execution to avoid conflicts in the instruction processing process so as to improve the overall performance and guarantee the accuracy of processing results.

To settle the above technical issue, the invention provides a pipelined decoding microarchitecture design method for RISC-V vector instructions, which is implemented by the following technical solution:

A pipelined decoding microarchitecture design method for RISC-V vector instructions, wherein a pipelined decoding microarchitecture design refers to a design of a processor core, and the processor core includes a program counter (PC), an instruction block corresponding to an address of the PC, multiple decoders, an instruction cache, an instruction buffer and multiple registers;
the pipelined decoding microarchitecture design method includes the following steps:
S1, designing an instruction fetch module: fetching an instruction packet according to the PC, wherein the instruction packet includes multiple instructions, and each instruction is one of a vector instruction, a configuration instruction and a branch instruction and has been coded; preprocessing each operational code corresponding to each instruction, and writing a preprocessing result, instruction fields of each instruction and instruction information of each instruction into the instruction cache;
S2, designing a pre-decoding module: reading data written into the instruction cache in S1, and performing pre-decoding to obtain pre-decoding result data, and recognizing each configuration instruction according to the pre-decoding result data, wherein the pre-decoding result data include one or more of each configuration instruction, each vector instruction, each branch instruction and the preprocessing result;
S3, designing an instruction buffer module: transmitting the pre-decoding result data obtained in S2 into the instruction buffer, acquiring, from the instruction buffer, field information in an immediate value field in each instruction and a split quantity of each instruction, and acquiring predicted vtype information corresponding to each configuration instruction by means of the field information or the multiple registers;
splitting, based on the predicted vtype information corresponding to each configuration instruction and the instruction fields of each instruction in S1, each vector instruction and each branch instruction into multiple microoperations according to the corresponding split quantity to construct a queue, storing each configuration instruction and each microoperation by the queue, and taking information of each microoperation as a control logic of the queue; and
S4, designing a decoding module: transmitting first, by means of the queue constructed in S3, each configuration instruction into the multiple decoders for decoding and execution, acquiring vtype information generated after execution of each configuration instruction, and determining whether the vtype information generated after execution of each configuration instruction is identical with the corresponding predicted vtype information;
if the vtype information generated after execution of each configuration instruction is not identical with the corresponding predicted vtype information, returning to S2, reading each configuration instruction from the instruction cache, replacing the predicted vtype information corresponding to each configuration instruction obtained in S3 with the corresponding vtype information generated after execution, and performing operations in S3again on each configuration instruction until decoding and execution in S4 are completed; or,
if the vtype information generated after execution of each configuration instruction is identical with the corresponding predicted vtype information, using the control logic and the split quantity in S3 as a control signal to control the number of microoperations input from the queue to the multiple decoders, and after the multiple decoders decode each microoperation input thereto, transmitting a decoding result to an instruction slot, and executing the decoding result in the instruction slot.

According to the invention, instructions are split and then input to decoders to be decoded, such that the problem of instruction conflicts is solved, and synchronous running of vector register files and superscalar processors supporting register renaming and out-of-order execution is realized; and in the decoding stage, related data of configuration instructions are acquired first, such that other instructions to be executed do not need to wait for information of the configuration instructions, thus increasing the processing speed and improving the processing performance; in addition, when an error occurs in instruction transmission or true vtype information is not identical with predicted vtype information, instruction fetching will be reperformed, thus guaranteeing the accuracy of processing results.

Preferably, in S1, a method for preprocessing each operational code corresponding to each instruction includes: based on a coding form of each instruction, performing information extraction on each operational code according to a corresponding instruction type and different code information from other instructions, and storing extracted information in the instruction cache. Different types of instructions correspond to different code information, vector instructions, configuration instructions and branch instructions can be distinguished timely according to different code information and are coded, such that overall efficiency is guaranteed; the branch instructions are processed to ensure that branch jump information can be determined in the subsequent pre-decoding stage; and when a branch jump occurs, predicted configuration instruction information obtained by decoding a false branch decoding will be eliminated, and instruction fetching will be reperformed according to a correct jump path, such that processing accuracy and performance are improved.

Preferably, in S1, the configuration instruction includes at least one vsetvl instruction, at least one vsetvli instruction or at least one vsetivli instruction; wherein, each vsetvli instruction and each vsetivli instruction include corresponding field information, and vtype information corresponding to each vsetvl instruction is saved in any one of the registers. The configuration instructions may be of different types and the number of the configuration instructions may be more than one, so desired information should be acquired according to the specific types of the configuration instructions and features of stored information corresponding to each specific type, so as to guarantee the accuracy of data.

Preferably, in S3, after the queue is constructed, the multiple microoperations split from each instruction are screened to remove invalid microoperations, and then remaining microoperations are stored in the queue. There may be some useless instructions, instructions that do not need to be executed, or instructions that are destroyed in the instruction transmission process, and by timely screening and eliminating microoperations corresponding to these invalid instructions, the accuracy of instruction transmission can be guaranteed, adverse effects of these invalid instructions on subsequent operations are avoided, and the performance will not be affected.

Preferably, in S3, a method for acquiring predicted vtype information corresponding to each configuration instruction includes: (1) for each vsetvli instruction or each vsetivli instruction: reading the field information in S3, and acquiring predicted vtype information corresponding to each vsetvli instruction or each vsetivli instruction according to the field information; (2) for each vsetvl instruction: acquiring nearest vtype information from the multiple registers and taking the acquired nearest vtype information as predicted vtype information. According to different types of configuration instructions, corresponding predicted vtype information is acquired to ensure smooth proceeding of queue transmission and decoding and is compared with subsequent information, such that the accuracy of transmission is further guaranteed, and whether an error occurs during instruction transmission is monitored.

Preferably, in S4, a method for acquiring vtype information generated after execution of each configuration instruction includes: (1) for each vsetvli instruction or each vsetivli instruction: reading field information generated after each vsetvli instruction or each vsetivli instruction is executed, and taking the field information generated after each vsetvli instruction or each vsetivli instruction is executed as corresponding vtype information generated after execution; (2) for each vsetvl instruction: after each vsetvl instruction is executed in S4, extracting corresponding vtype information from the multiple registers, and taking the extracted vtype information as vtype information generated after execution. After the configuration instructions are executed in the decoding stage, corresponding vtype information generated after each configuration instruction is executed is acquired again, such that the accuracy of data can be verified twice; and particularly for a vsetvl, the overall processing performance is improved by means of a predicted value, and then the value obtained after the instruction is executed is compared with the predicted value to guarantee the accuracy.

Preferably, in S4, the control signal is also used for controlling the number of microoperations entering the queue. The number of microoperations entering the queue is controlled, such that resource competitions of a large quantity of instructions in the queue are reduced, and a delay caused by the storage of a large quantity of instructions is also reduced.

Preferably, the multiple decoders include at least one full function decoder, at least one complex decoder and at least two simple decoders. Simple decoders cannot split instructions and are configured to process non-split instructions, a full function decoder can decode and split all instructions, and a complex decoder can decode and split instructions including one to more microoperations, and all these decoders work together to ensure that decoding can proceed smoothly, thus guaranteeing decoding efficiency and overall performance.

Compared with the prior art, the invention has the following beneficial effects:

According to the technical solution of the invention, instructions are split and then input to decoders to be decoded, such that the problem of instruction conflicts is solved, and the problem that vector register files and superscalar processors supporting register renaming and out-of-order execution cannot run synchronously is also solved; and configuration instructions are recognized in advance in the pre-decoding stage, and related data of the configuration instructions are acquired, such that other instructions do not need to wait for information of the configuration instructions in the decoding stage, thus increasing the processing speed and improving the processing performance; in addition, when an error occurs in instruction transmission or true vtype information is not identical with predicted vtype information, instruction fetching will be reperformed, thus guaranteeing the accuracy of processing results.

### BRIEF DESCRIPTION OF THE DRAWINGS

FIGURE is a flow diagram of a pipelined decoding microarchitecture design method for RISC-V vector instructions.

### DETAILED DESCRIPTION OF THE EMBODIMENTS

The technical solutions in some embodiments of the invention are described in detail below in conjunction with drawings of these embodiments.

As shown in FIGURE which is a flow diagram of a pipelined decoding microarchitecture design method for RISC-V vector instructions, the problem of instruction conflicts between vector register files and superscalar processors supporting register renaming and out-of-order execution is solved by instruction splitting, the processing performance is improved by constructing a queue and acquiring information of configuration instructions in advance, and the accuracy in the processing process is guaranteed.

A pipelined decoding microarchitecture design method for RISC-V vector instructions is a method for designing a microarchitecture, in a processor core, that decodes RISC-V vector configuration instructions and other instructions by stages in the form of a pipeline, that is, such a microarchitecture design is a design of the processor core, and the processor core at least includes a program counter (PC), multiple decoders, an instruction cache, an instruction buffer and multiple registers.

The PC is located in an instruction fetch module and used for fetching instructions in a processor; an address of the PC corresponds to an instruction block, which is a consecutive instruction sequence or an instruction set; and when the processor needs to fetch an instruction, an address stored in the PC will be sent to a memory in the processor core, and then the memory reads an instruction from a corresponding address in the instruction block. The multiple decoders are located in a decoding module and include at least one full function decoder, at least one complex decoder and at least two simple decoders, wherein the full function decoder can decode and split all instructions and is configured to ensure that any instructions can be processed, the complex decoder can decode and split instructions including 1-2 microoperations, the simple decoders can only process non-split instructions, and all these decoders work together to ensure that each instruction can be effectively decoded. The instruction cache is a high-speed cache and is configured to read and write data. The instruction buffer is a buffer zone for managing instructions, is configured to store instructions and other related information and can interact with other modules. The multiple registers are configured to store various data that possibly appear in an instruction pipeline and at least include multiple control and status registers (CSRs) for storing microoperation data of instructions, a rs2 register, and a vtype register in the rs2 register.

Specifically, the design method includes the following steps:

S1, an instruction fetch module is designed: an instruction packet is extracted from the PC, wherein the instruction packet includes multiple instructions, the instructions in the instruction packet may be vector instructions, configuration instructions and branch instructions, the number of each type of instructions may be 0 or at least one, and each instruction has been coded; and each operational code corresponding to each instruction is preprocessed, and a preprocessing result and each instruction are written into the instruction cache. The fetched instructions have been coded with conditional codes, error correction codes (ECCs) or other codes as long as data can be protected. In addition, it should be noted that in the process from instruction fetching to subsequent decoding, the same coding form and decoding form should be adopted to ensure instructions can be processed smoothly.

In this embodiment, in S1, each operational code corresponding to each instruction is preprocessed as follows: when instruction data input to the instruction cache are preprocessed according to the address of the PC, each operational code is preprocessed according to the coding form of each instruction, and extracted vector instruction information, vector configuration instruction information and branch instruction information are coded together and then stored in the instruction cache. Then, a subsequent decoding operation is performed according to the decoding form adopted in the instruction fetch process to ensure transmission and decoding efficiency. Codes obtained during preprocessing include branch instruction information to ensure that branch instructions can be quickly recognized in the decoding stage to determine whether a jump occurs; and when a branch jump occurs, predicted configuration instruction information obtained by decoding a false branch will be eliminated, and instruction fetching will be reperformed according to a correct jump path, such that processing performance is improved. Different types of instructions correspond to different code information, vector instructions, configuration instructions and branch instructions can be distinguished timely according to different code information and are coded, and the branch instructions are processed to ensure that branch jump information can be determined in the subsequent pre-decoding stage; and when a branch jump occurs, predicted configuration instruction information obtained by decoding a false branch decoding will be eliminated, and instruction fetching will be reperformed according to a correct jump path, such that processing accuracy and performance are improved.

In this embodiment, the configuration instruction may be a vsetvl instruction, a vsetvli instruction or a vsetivli instruction, and the number of each type of instructions is uncertain and may be 0 or at least one. Each vsetvli instruction and each vsetivli instruction include field information of corresponding vtype registers, the field information is included in instruction codes, each vsetvl instruction includes corresponding vtype data, the vtype data are type data of nonprivileged SCRs and are saved in a scalar register. Generally, one vtype register can store multiple pieces of vtype data of multiple instructions. However, in case of multiple configuration instructions, multiple vector instructions cannot share information in the same vtype register for configuration.

S2, a pre-decoding module is designed: data written in the instruction cache in S1 are read and pre-decoded to obtain pre-decoding result data, and each configuration instruction is recognized by means of the pre-decoding result data according to the preprocessed operational code of the vector instruction, the preprocessed operational code of the branch instruction and a preprocessed functional code of the configuration instruction, different configuration instructions are distinguished in the pre-decoding stage according to the last two bits of 32 bit configuration instructions, and finally, the specific type of each configuration instruction and field information related to the configuration instruction such as vtype register information of an immediate value field are obtained, wherein the pre-decoding result data include one or more of each configuration instruction, each vector instruction, each branch instruction and the preprocessing result.

S3, an instruction buffer module is designed: the pre-decoding result data obtained in S2 are transmitted into the instruction buffer, such that field information in all the instructions, a split quantity of each instruction and other information can be obtained from the instruction cache. Predicted vtype information in each vsetvli instruction or each vsetivli instruction can be obtained by means of instruction type data in the field information. For the vsetvl instruction, a vtype value of the vsetvl instruction is predicted by speculative execution, that is, vtype data of nearest data are selected from the vtype register to be used as vtype information of the vsetvl instruction; after the configuration is executed in the decoding stage, vtype information generated after execution of the vsetvl instruction is read from the vtype register, and the two pieces of vtype information are compared; if the two pieces of vtype information are identical, the next step is performed; or, if the two pieces of vtype information are different, it indicates that an error appears, and the step of instruction fetching is repeated to reperform the task.

To solve the problem of instruction conflicts, each vector instruction needs to be split into multiple microoperations in the instruction buffer according to the corresponding split quantity to construct a queue, each configuration instruction and each microoperation are stored in the queue, information of each microoperation is used as a control logic of the queue, the control logic includes a relation between different microoperations, and microoperations belonging to the same instruction are determined according to the relation; and the control logic also includes the number of microoperations split from each vector instruction and a transmission sequence determined according to the number of the microoperations. For any one vector instruction, the number of microoperations split from the vector instruction should match the specification of decoders adopted by the processor core and should not exceed a maximum number of microoperations that can be processed by the decoders; and when any one microoperation of one instruction is destroyed or lost, this instruction cannot be used anymore, that is, other microoperations in the instruction also become invalid.

In this embodiment, in S3, after being constructed, the queue will sequentially store various instructions, microoperations and other related data in the instruction buffer; and an output mechanism will be set in the queue, the multiple microoperations split from each instruction are screened to eliminate invalid microoperations, and remaining microoperations are stored in the queue. For each split vector instruction, the queue will synchronously store all microoperations corresponding to the instruction, and the situation where the queue only stores a proportion of the microoperations corresponding to the instruction and does not store other microoperations corresponding to the instruction will not occur, such that the integrity of the instruction is guaranteed; and particularly, the situation where the decoders only process a proportion of the microoperations corresponding to the instruction when the queue transmits the instruction or microoperations to the multiple decoders is avoided, such that the accuracy of data transmission is guaranteed.

It should be noted that when any one instruction is split, the number of microoperations split from the instruction can be obtained according to field information of the instruction, instruction information (such as instruction length) and other data of the instruction, for example, the instruction may be split into three microoperations or five microoperations; then, it can be determined, according to corresponding vtype data of the configuration instruction or vacancy requirements of the queue, that the vector instruction needs to be split into three microoperations.

In addition, the split quantity of an instruction may be 0. For example, if an instruction is too short to split, it will not be split. In a case where an instruction queue is long enough and the whole processing speed will not be affected even if part of instructions is not split, these instructions may not be split; or, instructions that are prohibited from being split as required, these instructions will not be split.

S4, a decoding module is designed: by means of the queue constructed in S3, each configuration instruction is first transmitted into the multiple decoders to be decoded, split in the decoders into microoperations according to configuration instruction information, and after being renamed by a register, sent to an execution stage to perform a configuration operation, an effective element width and size of an operand are configured for the vector instruction to be executed, and after each configuration instruction is executed, for each vsetvli instruction or each vsetivli instruction, the predicted vtype information is taken as the corresponding vtype information generated after execution; for each vsetvl instruction, corresponding vtype information is extracted from the vtype register of the multiple registers, and the vtype information extracted from the vtype register is taken as the corresponding vtype information generated after execution. Then, whether the vtype information generated after execution of each instruction is identical with the corresponding predicted vtype information is determined; if the vtype information generated after execution of each instruction is not identical with the corresponding predicted vtype information, it indicates that the predicted vtype information obtained by speculative execution is erroneous, S2 is performed again to read each configuration instruction from the instruction cache, the predicted vtype information obtained in S3 is replaced with the corresponding vtype information generated after execution, and operations in S3 are repeated for each configuration instruction until decoding and execution in S4 are completed; or, if the vtype information generated after execution of each instruction is identical with the corresponding predicted vtype information, the control logic and split quantity obtained in S3 are used as a control signal to control the number of microoperations input from the queue to the multiple decoders, and after the multiple decoders decode each microoperation input thereto, a decoding result is transmitted to an instruction slot and executed in the instruction slot to complete renaming and other operations to be executed.

In this embodiment, the queue periodically and sequentially stores various instructions, fields, microoperations and other data in the instruction cache. In each period, because vtype data of configuration instructions are needed when vector instructions are executed in the decoding stage, the configuration instructions will be output first to obtain corresponding vtype data to avoid the situation where a vector instruction is output without corresponding vtype data and has to wait is avoided, thus improving overall processing efficiency and performance.

In addition, the control signal is also used for controlling the number of microoperations entering the queue. An upper limit is set for the queue to ensure that instructions or microoperations within a fixed quantity range are processed in each period to avoid the situation where the memory pressure and delay are increased and resource competitions are caused due to excessive data processed in each period. The control signal is used to control the number of microoperations to avoid such a situation and is also used to control the number of microoperations input from the queue to the decoding stage.

Specific application example:

A PC, four decoders, an instruction cached, an instruction buffer, a nonprivileged vtype register and a scalar register are configured in a processor core. The four decoders include a full function decoder, a complex decoder and two simple decoders. The scalar register may include vtype register information.

Instruction fetching is performed according to the PC to obtain an instruction packet, wherein the instruction packet includes eight instructions that need to be preprocessed before being input to the instruction cache. The eight instructions to be preprocessed are RISC-V instructions with specific operational codes and are preprocessed according to functions corresponding to the operational codes. When a branch instruction is obtained by decoding the operational code, jump information of the instruction will be recoded, and configuration instruction information, eight instruction fields and branch instruction information obtained after coding are written into the instruction cache. Then, data in the instruction cache are processed, whether there is one of a vsetvl instruction, a vsetvli instruction and a vsetivli instruction is recognized first in a pre-decoding stage, and information, stored in the vtype register, in intermediate value fields of the three configuration instructions is predicted and taken as predicted vtype register information.

In the pre-decoding stage, vector instructions and configuration instructions will be decoded, and fields of remaining instructions will be pipelined to an instruction buffer stage according to instruction information; in the instruction buffer stage, the attribute of each field of each instruction is decoded, such that whether a register field of each instruction is a vector register, a scalar register, a floating-point register or an immediate value can be decoded as soon as possible to ensure that a renaming logic can be determined quickly in a subsequent decoding stage.

In the instruction buffer stage, field information of all instructions, a split quantity of each vector instruction and other information are acquired from the instruction buffer. According to instruction type data included in the field information, vtype information corresponding to the vsetvli instruction and the vsetivli instruction is predicted; for the vsetvl instruction, a vtype value of the vsetvl instruction is predicted by speculative execution, that is, nearest vtype data are selected from the vtype register to be taken as predicted vtype information corresponding to the vsetvl instruction; after the configuration instruction is executed in the decoding stage, vtype information generated after the vsetvl instruction is executed is read again from the vtype register, and the two pieces of vtype information are compared. In the instruction buffer, each vector instruction is split into multiple microoperations, then a queue is constructed, each instruction and each microoperation are sequentially stored in the queue, an output mechanism is set in the queue, the multiple microoperations spit from each instruction are screened to eliminate invalid microoperations, remaining microoperations are stored in the queue, and information of each remaining microoperation is used as a control logic of the queue.

The queue first transmits three configuration instructions to the multiple decoders in the decoding stage; after the configuration instructions are executed, true vtype information generated after the vsetvli instruction and the vsetivli instruction are executed are compared with the vtype information predicted in the instruction buffer stage; if the true vtype information is not identical with the predicted vtype information, instruction fetching is reperformed; or, if the true vtype information is identical with the predicted vtype information, instructions are output according to an entry rule of a decoding module; current vtype information of the vsetvl instruction is compared with the previously predicted vtype information of the vsetvl instruction; if the current vtype information is not identical with the previously predicted vtype information, the queue will be emptied, and instruction fetching will be reperformed; or, if the current vtype information is identical with the previously predicted vtype information, the queue is controlled to input vector instructions to the multiple decoders according to a decoding rule of the output instructions. The entry rule of the decoding module is that after the queue outputs the configuration instructions, each vector instruction should follow the following specific input rule:
in a case where the first vector instruction is split into more than two microoperations, the first vector instruction will enter the decoding module and exclusively occupy the decoding pipeline stage, and the other vector instructions will be stored in the instruction queue temporarily; in a case where the first vector instruction is split into one to two microoperations and the second vector instruction is split into more than three microoperations, the first vector instruction will enter a decoding unit and exclusively occupy the decoding pipeline stage, and the other vector instructions will be stored in the instruction queue temporarily; in a case where the first vector instruction is split into one to two microoperations, the second vector instruction is split into one to two microoperations and the third vector instruction is split into more than one microoperation, the first vector instruction and the second vector instruction will enter the next pipeline stage, and the other vector instructions will enter the instruction queue; in a case where the first vector instruction is split into one to two microoperations, the second vector instruction is also split into one to two microoperations, the third vector instruction is split into one microoperations and the fourth vector instruction is split into more than one microinstruction, the first three vector instruction will enter the next pipeline stage, and the other instructions will enter the instruction queue; and in a case where the first vector instruction is split into one to two microoperations, the second vector instruction is also split into one to two microoperations, the third vector instruction is split into one microoperation and the fourth vector instruction is split into one microinstruction, the first four instructions will enter the next pipeline stage, and the other instructions will enter the instruction queue.

When the queue sequentially inputs vector instructions and microoperations to the decoders, the four decoders can synchronously decode and split four instructions every time and correspond to eight instruction transmission channels, and processed microoperations are transmitted to an instruction slot by means of the instruction transmission channels to continuously provide instructions for a subsequent renaming and instruction execution unit. After four instructions are decoded, the queue inputs remaining instructions and microoperations to the decoders until all instructions and microoperations to be decoded are completed.

According to the invention, instructions are split and then input to decoders to be decoded, such that the problem of instruction conflicts is solved, and synchronous running of vector register files and superscalar processors supporting register renaming and out-of-order execution is realized; and in the decoding stage, related data of configuration instructions are acquired first, such that other instructions to be executed do not need to wait for information of the configuration instructions, thus increasing the processing speed and improving the processing performance; in addition, when an error occurs in instruction transmission or true vtype information is not identical with predicted vtype information, instruction fetching will be reperformed, thus guaranteeing the accuracy of processing results.

The above embodiments are merely used for explaining the technical concept of the invention and are not intended to limit the protection scope of the invention. Any modifications made based on the technical concept of the invention should also fall within the protection scope of the invention.

What is claimed is:

1. A pipelined decoding microarchitecture design method for Reduced Instruction Set Computing-Version Five (RISC-V) vector instructions, wherein a pipelined decoding microarchitecture design refers to a design of a processor core, and the processor core comprises a program counter (PC), an instruction block corresponding to an address of the PC, a plurality of decoders, an instruction cache, an instruction buffer and a plurality of registers;
the pipelined decoding microarchitecture design method comprises the following steps:
S1, designing an instruction fetch module: fetching an instruction packet according to the PC, wherein the instruction packet comprises a plurality of instructions, and each instruction is one of a vector instruction, a configuration instruction and a branch instruction and has been coded; preprocessing each operational code corresponding to each instruction, and writing a preprocessing result, instruction fields of each instruction and instruction information of each instruction into the instruction cache;
S2, designing a pre-decoding module: reading data written into the instruction cache in S1, performing pre-decoding to obtain pre-decoding result data, and recognizing each configuration instruction according to the pre-decoding result data, wherein the pre-decoding result data comprise one or more of each configuration instruction, each vector instruction, each branch instruction and the preprocessing result;
S3, designing an instruction buffer module: transmitting the pre-decoding result data obtained in S2 into the instruction buffer, acquiring, from the instruction buffer, field information in an immediate value field in each instruction and a split quantity of each instruction, and acquiring predicted vtype information corresponding to each configuration instruction by the field information or the plurality of registers;
splitting, based on the predicted vtype information corresponding to each configuration instruction and the instruction fields of each instruction in S1, each vector instruction and each branch instruction into a plurality of microoperations according to the corresponding split quantity to construct a queue, storing each configuration instruction and each microoperation by the queue, and taking information of each microoperation as a control logic of the queue; and
S4, designing a decoding module: transmitting first, by the queue constructed in S3, each configuration instruction into the plurality of decoders for decoding and execution, acquiring vtype information generated after execution of each configuration instruction, and determining whether the vtype information generated after execution of each configuration instruction is identical with the corresponding predicted vtype information; wherein
when the vtype information generated after execution of each configuration instruction is not identical with the corresponding predicted vtype information, returning to S2, reading each configuration instruction from the instruction cache, replacing the predicted vtype information corresponding to each configuration instruction obtained in S3 with the corresponding vtype information generated after execution, and performing operations in S3 again on each configuration instruction until decoding and execution in S4 are completed; or,
when the vtype information generated after execution of each configuration instruction is identical with the corresponding predicted vtype information, using the control logic and the split quantity in S3 as a control signal to control a number of the plurality of microoperations input from the queue to the plurality of decoders, and after the plurality of decoders decode each microoperation input thereto, transmitting a decoding result to an instruction slot, and executing the decoding result in the instruction slot.

2. The pipelined decoding microarchitecture design method according to claim 1, wherein in S1, a method for preprocessing each operational code corresponding to each instruction comprises: based on a coding form of each instruction, performing information extraction on each operational code according to a corresponding instruction type and different code information from other instructions, and storing extracted information in the instruction cache.

3. The pipelined decoding microarchitecture design method according to claim 1, wherein in S1, the configuration instruction comprises at least one vsetvl instruction, at least one vsetvli instruction or at least one vsetivli instruction;
wherein, each vsetvli instruction and each vsetivli instruction comprise corresponding field information, and vtype information corresponding to each vsetvl instruction is saved in any one of the plurality of registers.

4. The pipelined decoding microarchitecture design method according to claim 1, wherein in S3, after the queue is constructed, the plurality of microoperations split from each instruction are screened to remove invalid microoperations, and then remaining microoperations are stored in the queue.

5. The pipelined decoding microarchitecture design method according to claim 3, wherein in S3, a method for acquiring the predicted vtype information corresponding to each configuration instruction comprises:
(1) for each vsetvli instruction or each vsetivli instruction: reading the field information in S3, and acquiring the predicted vtype information corresponding to each vsetvli instruction or each vsetivli instruction according to the field information; and
(2) for each vsetvl instruction: acquiring nearest vtype information from the plurality of registers and taking the nearest vtype information as the predicted vtype information.

6. The pipelined decoding microarchitecture design method according to claim 5, wherein in S4, a method for acquiring the vtype information generated after execution of each configuration instruction comprises:
(1) for each vsetvli instruction or each vsetivli instruction: reading field information generated after each vsetvli instruction or each vsetivli instruction is executed, and taking the field information generated after each vsetvli instruction or each vsetivli instruction is executed as corresponding vtype information generated after execution; and
(2) for each vsetvl instruction: after each vsetvl instruction is executed in S4, extracting corresponding vtype information from the plurality of registers, and taking the extracted vtype information as vtype information generated after execution.

7. The pipelined decoding microarchitecture design method according to claim 1, wherein in S4, the control signal is also used for controlling the number of the plurality of microoperations entering the queue.

8. The pipelined decoding microarchitecture design method according to claim 1, wherein the plurality of decoders comprise at least one full function decoder, at least one complex decoder and at least two simple decoders.
